(19) United States
(12) Patent Application Publication
(10) Pub. No.: US 2006/0045051 A1
(43) Pub. Date: Mar. 2, 2006

(54) Method and system for a quality of service mechanism for a wireless network

(76) Inventors: Andreas Floros, Patras (GR); Theodore Karoubalis, Peiraias (GR)

Correspondence Address: SAWYER LAW GROUP LLP, P O BOX 51418, PALO ALTO, CA, 94303, US

(21) Appl. No.: 10/986,344

(22) Filed: Nov. 10, 2004

(30) Foreign Application Priority Data
Aug. 30, 2004 (GR) 20040100344

(51) Int. Cl. H04Q 7/00

(52) U.S. Cl. 370/332

(57) ABSTRACT

A quality of service mechanism for a wireless network includes reserving time for contention-based transmissions of station devices under a polling-based channel access function in an access point. Also included is deriving a scheduled polling service under access rules of the polling-based channel access function, wherein admission capability and bandwidth management of the wireless network are enhanced.

### FIELD OF THE INVENTION

The present invention relates to wireless communication networks, and more particularly to a quality of service mechanism for reducing bandwidth losses and increasing admission capability.

### BACKGROUND OF THE INVENTION

Wireless communications have grown tremendously over the past few years, becoming widely applied to the realm of personal and business computing. Wireless access is quickly broadening network reach by providing convenient and inexpensive access in hard-to-wire locations. A major motivation and benefit from wireless LANs is increased mobility. Wireless network users are able to access LANs from nearly anywhere without being bounded through a conventional wired network connection.

The IEEE 802.11 standard for wireless LANs (WLANs) stands as a significant milestone in the evolution of wireless network technologies. Currently being specified in IEEE 802.11e is a set of quality of service (QoS) enhancements to the medium access control (MAC). For purposes of this discussion, references to the 802.11e specification correspond to IEEE80211 WG, IEEE802.11e/D8.0, “Draft Amendment to Standard for Information Technology—Telecommunications and Information Exchange between Systems—LAN/MAN Specific Requirements—Part 11: Wireless Medium Access Control (MAC) and Physical Layer (PHY) Specifications: Medium Access Control (MAC) Quality of Service (QoS) Enhancements,” February 2004. QoS refers to a networking term and the concept of being able to control and measure data transmission rates or throughput and error rates. Specifically, QoS refers to implementing guarantees of meeting specified data transmission rates and error percentages.

Included in the MAC (media access control) sub-layer of the 802.11e architecture is a hybrid coordination function (HCF) that uses a contention-based channel access method, called enhanced distributed channel access (EDCA). EDCA generally provides differentiated, distributed access to the wireless medium using different levels of priorities. HCF also implements a contention-free hybrid controlled channel access (HCCA) method, which is based on a polling mechanism between a hybrid coordinator (HC) located within a quality of service access point (QAP) and the pollable quality of service stations (QSTAs). A QAP and QSTAs form a quality of service basic service set (QBSS), as illustrated in the wireless network diagram 10 in FIG. 1. Both EDCA and HCCA result in specific time-length transmission opportunities (TXOPs) granted to QSTAs for data transmissions. However, while EDCA can be implemented as a stand-alone access method, HCCA requires the presence of a contention-based method (e.g., EDCA) at least in order to establish the polling mechanism between the HC and QSTAs.

As defined in the 802.11e proposed specification, using the HCCA channel access method, HC traffic delivery and TXOP allocation may be scheduled during both the CFP (Contention Free Period) and CP (Contention Period) intervals in order to meet the QoS requirements of particular traffic streams (TSs) described in detail by appropriate traffic specification (TSPEC) elements. The transfer protocol under HCCA is based on a polling scheme controlled by the HC with each granted TXOP defined by an implicit starting time and a defined maximum length. These parameters are derived by a service scheduler (SeS) of the HC, taking into account the TSPEC values sent to the HC from the requesting QSTAs. The SeS finally follows the calculated service schedule, providing a ‘guaranteed channel access’ to the accepted traffic streams.

As shown in FIG. 2, the SeS 20 is responsible for granting polling service through TXOPs to the QSTAs and their QoS traffic streams. If a TS (and its corresponding TSPEC) is admitted by the admission control unit (ACU), the scheduler is responsible for granting channel access to this TS based on the negotiated TSPEC parameters. This access is offered in terms of TXOPs that satisfy the service schedule. The SeS 20 sends polls within specific time interval lengths (also defined in the TSPEC as the maximum service interval value), defining the duration of the allowed TS transmission (i.e., the TXOP duration).

In order to successfully set up a service schedule, a minimum set of TSPEC parameters must be defined during TSPEC negotiation: a) the mean data rate b) the nominal MSDU size and c) at least one of the maximum service interval and the delay bound. The HC may also admit a TSPEC with an alternative set of TSPEC parameters. In such a case, these parameters are indicated to the destination QSTA.

The simple scheduler reference design proposed by the 802.11e specification was found to induce significant bandwidth losses, which reduce the overall admission capacity. Thus, a need exists for reducing these losses. The present invention addresses such a need.

### SUMMARY

Aspects for a quality of service mechanism for a wireless network are described. The aspects include reserving time for contention-based transmissions of station devices under a polling-based channel access function in an access point. Also included is deriving a scheduled polling service under access rules of the polling-based channel access function, wherein admission capability and bandwidth management of the wireless network are enhanced.

Through the present invention, a scheduling mechanism is provided that significantly reduces the unused TXOPs length in order to increase the admission capacity of the service area by using an improved TXOP calculation formula. The scheduling mechanism further expands the length of TXOPs granted to the different traffic streams in order to avoid queue overflows when certain criteria are met or provides extra TXOPs at the end of the schedule, such that the stations may use it for emptying the loaded data queues. In addition, the maximum service interval traffic stream parameters are preserved, and the scheduling mechanism is transparent to all client devices in a service set area, thus aiding adoption of the mechanism in an interoperable system. These and other advantages of the aspects of the present invention will be more fully understood in conjunction with the following detailed description and accompanying drawings.

### BRIEF DESCRIPTION OF THE DRAWINGS

FIG. 1 illustrates a system diagram of a prior art wireless network.

FIG. 2 illustrates hybrid coordinator of the QAP of FIG. 1.

FIG. 3 illustrates a typical TXOP schedule timing diagram.

FIG. 4 illustrates a system diagram of a wireless network that includes a scheduling mechanism in accordance with the present invention.

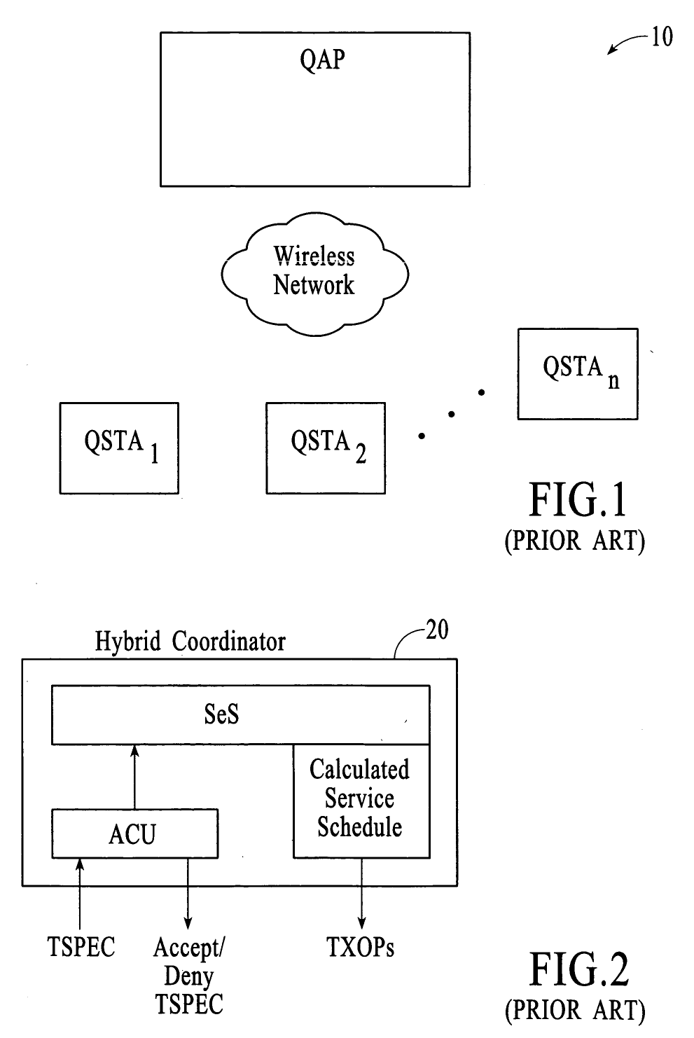

### DETAILED DESCRIPTION

The present invention relates to quality of service mechanism for reducing bandwidth losses and increasing admission capability. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

The simple scheduler proposed by the 802.11e specification uses the mandatory set of TSPEC parameters: mean data rate, nominal MSDU size, and maximum service interval, in order to generate a schedule service, while meeting minimum defined performance requirements. Briefly, the simple scheduler calculates the TXOP length corresponding to the i-th QSTA using the following equation:

$${TXOP}_{i} = max ( ⌈ \frac{{Sixp}_{i}}{{L}_{i}} ⌉ \frac{{L}_{i}}{{R}_{i}} + {O}_{i} \frac{M}{{R}_{i}} + O ) \qquad ( 1 )$$

In the equation (1), p is the TSPEC mean data rate in bits per second, L and M are the nominal and maximum allowable MDSU size (in bits), respectively, and R is the physical transmission rate negotiated in the TSPEC (in bits per second). The overhead, O, value (in seconds) represents the overhead introduced by the MAC layer, including interframe spaces, ACKs, and CF-Polls and should be calculated for every TS. The parameter SI represent the scheduled service interval calculated as the first sub-multiple of the beacon interval that is less than the minimum of all maximum service interval for all admitted streams.

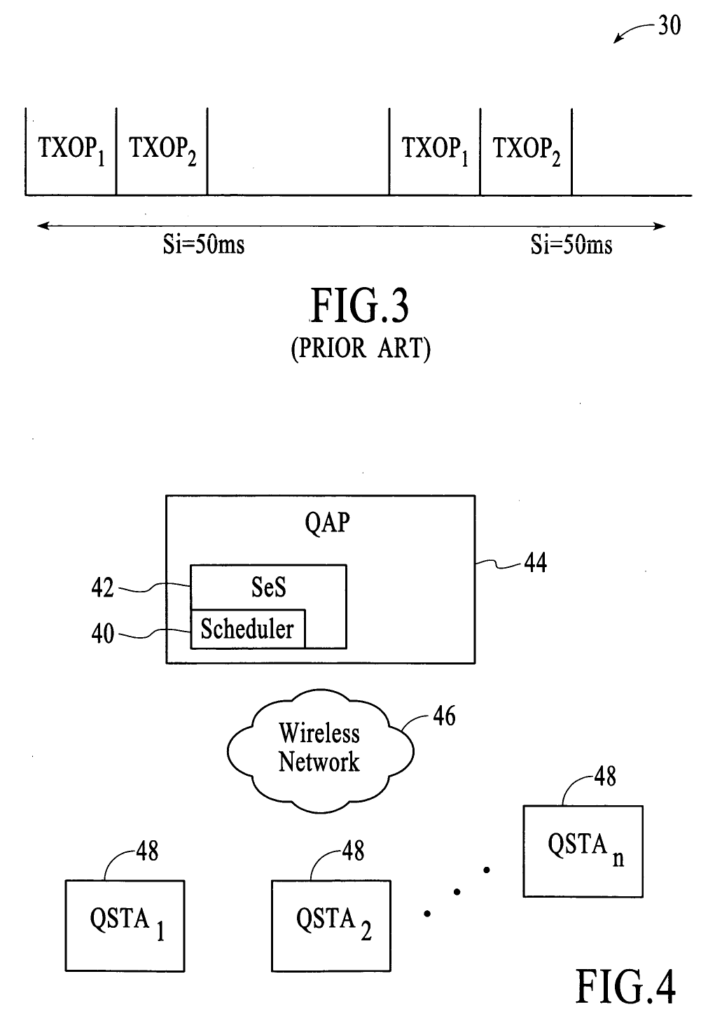

Using the simple scheduler, the TXOP starting time is constant within each SI, as the polling operation is performed in a serial manner. An example 30 is illustrated in FIG. 3, where SI=50 ms (milliseconds) and two polled STAs with 1 TS each are considered.

In order to derive a service schedule using this described simple scheduler, SI must be calculated as an appropriate sub-multiple of the beacon interval. However, the HCCA access method must interoperate with the contention based EDCA, hence a minimum time-length within each beacon interval must be reserved for EDCA traffic. It should be noted that this time reservation also affects the admission capabilities of the HC, as it decreases the available admission capacity.

In accordance with the present invention, the SI is calculated, as follows: Assuming that EDCAInterval is the time duration (in seconds) to reserve within the beacon interval and SImin (in seconds) is the minimum of all the admitted TSs (or TSPECs) maximum service interval values, the following inequalities must apply:
EDCAInterval<SIₘᵢₙ (2)
and
SIₘᵢₙ≧SI+EDCAInterval (3)

SI (in seconds) is the new service interval calculated as:

$$SI = \frac{BeaconInterval - EDCAInterval}{n} \qquad ( 4 )$$

where n is an integer defined as:

$$n = ⌈ \frac{BeaconInterval - EDCAInterval}{{SI}_{min} - EDCAInterval} ⌉ \qquad ( 5 )$$

For example, assuming a TS with SImin=60 ms, and EDCAInterval=10 ms, with a given BeaconInterval=100 ms, the SI equals 45 ms, while both equation (2) and equation (3) are satisfied.

In accordance with the present invention, a scheduling mechanism 40 is provided for an SeS 42 of a QAP 44 in a wireless network 46 which also includes QSTAs 48, as shown in FIG. 4. The scheduling mechanism 40 calculates the TXOPs lengths for every admitted stream based on the TSPEC parameters of each stream using the following equation:

$${TXOP}_{i} = \frac{{p}_{i} xBeaconInterval}{{R}_{i} xn} + O \qquad ( 6 )$$

where n is derived by equation (5). With these TXOP lengths , the SeS 40, using the scheduling method of the present invention, establishes the service schedule and starts polling the QSTAs, which use the granted TXOP for sending pending data belonging to a specific admitted TS. Within a polling TXOP, the QSTAs also send information about the pending data in the TS queue. For example, q(k) (in bytes), where k defines a TS within the TXOP owner QSTA with index i using the queue size parameter in the QoS control field of the frame transmitted. The scheduling mechanism 40 of the present invention aggregates this information obtained by all the serviced QSTAs (producing an overall value Q) and if the pending queue value q(k) is greater than a programmable threshold value Qthres, it attempts to expand the corresponding TXOP length by TXOPExapansionLength, determined by q(k), Q, and the unallocated channel access time in each SI that is not granted to TXOPs (and thus can be allocated to other requesting TSs.) This procedure is analytically described as:

$${TXOPExpansionLength}_{i} = \frac{q ( k )}{Q} ( SI - {\sum }_{i} {TXOP}_{i} ) \qquad ( 7 )$$

and
TXOP_{i,e}=TXOPᵢ+TXOPEpansionLengthᵢ (8)
where TXOPi,e denotes the total new TXOP length after expansion.

The TXOP expansion method in accordance with the present invention is performed on a predetermined basis, i.e., on a per beacon or per service interval basis. Thus, the TXOP expansion attempt is performed within every beacon or service interval. This allows the fair expansion of all the TSs with high traffic load, and when a TS is requesting service, the admission control unit decision is based on the non-expanded TXOP lengths. Hence, the TXOP expansion method does not affect the total admission capacity, which can still remain low.

Assuming that a TXOP that should be expanded occurs at a specific time instance within the SI equal to ti (in seconds), the expanded TXOP duration is granted by the HC only if it does not violate the maximum service interval of the TSs that are getting polled within the same SI after the time instance ti. In such a case, the TXOP is not expanded (TXOPi,e=TXOPi) but instead, the HC attempts to re-poll the specific QSTA immediately after the end of all the scheduled TXOP within current SI. The length of the additional TXOP equals the calculated TXOPExpansionLength. The HC re-polling may take place provided that there is enough transmission time prior to the beginning of the next scheduled SI, i.e.:

$${\sum }_{i} {TXOP}_{i , e} + TXOPExpansionLength + O \leq SI \qquad ( 9 )$$

Through the present invention, a scheduling mechanism is provided that significantly reduces the unused TXOPs length in order to increase the admission capacity of the service area by using an improved TXOP calculation formula. The scheduling mechanism further expands the length of TXOPs granted to the different traffic streams in order to avoid queue overflows when certain criteria are met or provides extra TXOPs at the end of the schedule, such that the stations may use it for emptying the loaded data queues. In addition, the maximum service interval traffic stream parameters are preserved, and the scheduling mechanism is transparent to all client devices in a service set area, thus aiding adoption of the mechanism in an interoperable system.

Although the present invention has been described in accordance with the embodiments shown, one of ordinary skill in the art will readily recognize that there could be variations to the embodiments and those variations would be within the spirit and scope of the present invention. For example, although the present invention has been described in the context of the 802.11 standard, one of ordinary skill in the art readily recognizes that the present invention could be utilized in a variety of wireless environments. Accordingly, many modifications may be made by one of ordinary skill in the art without departing from the spirit and scope of the appended claims.

What is claimed is:

1. A method for a quality of service mechanism for a wireless network, the method comprising:
reserving time for contention-based transmissions of station devices under a polling-based channel access function in an access point; and
deriving a scheduled polling service under access rules of the polling-based channel access function, wherein admission capability and bandwidth management of the wireless network are enhanced.

2. The method of claim 1 wherein reserving time further comprises defining a reserved-time length for contention-based transmissions.

3. The method of claim 2 wherein deriving a scheduled polling service further comprises calculating a service interval for scheduling transmission operations under the access rules.

4. The method of claim 3 wherein calculating a service interval further comprises calculating transmission operation lengths to be granted to all admitted traffic streams within one service interval, wherein a transmission operation length that is not used for actual transmissions is reduced.

5. The method of claim 4 further comprising expanding a length of transmission operations granted to admitted traffic streams on a predetermined basis in order to avoid possible queue overflows.

6. The method of claim 5 further comprising utilizing a pending queue value for each of the admitted traffic streams and an aggregated pending queue value to derive a required transmission operation expansion length.

7. The method of claim 6 further comprising utilizing a programmable threshold as a value needing to be reached by the pending queue value in order to trigger transmission operation length expansion.

8. The method of claim 7 further comprising preventing transmission operation length expansion when a maximum service interval parameter of the traffic streams that should be serviced after the transmission operation length expansion is violated.

9. The method of claim 8 further comprising re-polling traffic streams for which the transmission operation length expansion was not allowed substantially immediately after an end of all scheduled transmission operations within a current service interval using transmission operations with a length equal to the required transmission operation expansion length.

10. A system for a quality of service mechanism for a wireless network, the system comprising:
QSTAs (quality of service stations); and
a QAP (quality of service access point) networked to the QSTAs via the wireless network, the QAP reserving time for contention-based transmissions of the QSTAs under a polling-based channel access function in an access point, and deriving a scheduled polling service under access rules of the polling-based channel access function, wherein admission capability and bandwidth management of the wireless network are enhanced

11. The system of claim 10 wherein the QAP reserves time by defining a reserved-time length for contention-based transmissions.

12. The system of claim 11 wherein the QAP derives a scheduled polling service by calculating a service interval for scheduling transmission operations under the access rules.

13. The system of claim 12 wherein the QAP calculates transmission operation lengths to be granted to all admitted traffic streams within one service interval, wherein a transmission operation length that is not used for actual transmissions is reduced.

14. The system of claim 13 wherein the QAP further expands a length of transmission operations granted to admitted traffic streams on a predetermined basis in order to avoid possible queue overflows.

15. The system of claim 14 wherein the QAP further utilizes a pending queue value for each of the admitted traffic streams and an aggregated pending queue value to derive a required transmission operation expansion length.

16. The system of claim 15 wherein the QAP further utilizes a programmable threshold as a value needing to be reached by the pending queue value in order to trigger transmission operation length expansion.

17. The system of claim 16 wherein the QAP further prevents transmission operation length expansion when a maximum service interval parameter of the traffic streams that should be serviced after the transmission operation length expansion is violated.

18. The system of claim 17 wherein the QAP further re-polls traffic streams for which the transmission operation length expansion was not allowed substantially immediately after an end of all scheduled transmission operations within a current service interval using transmission operations with a length equal to the required transmission operation expansion length.

19. A method for a quality of service mechanism for a wireless network, the method comprising:
deriving a scheduled polling service under access rules of the polling-based channel access function to control transmission operations length, wherein unused transmission operation length is reduced, certain transmission operations length is expanded to avoid queue overflows, and provision of extra transmission operations at a schedule end occurs.

20. The method of claim 19 wherein deriving further comprises calculating transmission operation lengths to be granted to all admitted traffic streams within one service interval, utilizing a pending queue value for each of the admitted traffic streams and an aggregated pending queue value to derive a required transmission operation expansion length, utilizing a programmable threshold as a value needing to be reached by the pending queue value in order to trigger transmission operation length expansion, and re-polling traffic streams for which the transmission operation length expansion was not allowed substantially immediately after an end of all scheduled transmission operations within a current service interval using transmission operations with a length equal to the required transmission operation expansion length.

21. A computer readable medium containing program instructions for a quality of service mechanism for a wireless network, the program instructions for:
reserving time for contention-based transmissions of station devices under a polling-based channel access function in an access point; and
deriving a scheduled polling service under access rules of the polling-based channel access function, wherein admission capability and bandwidth management of the wireless network are enhanced

22. The computer readable medium of claim 21 wherein reserving time further comprises defining a reserved-time length for contention-based transmissions.

23. The computer readable medium of claim 22 wherein deriving a scheduled polling service further comprises calculating a service interval for scheduling transmission operations under the access rules.

24. The computer readable medium of claim 23 wherein calculating a service interval further comprises calculating transmission operation lengths to be granted to all admitted traffic streams within one service interval, wherein a transmission operation length that is not used for transmissions is reduced.

25. The computer readable medium of claim 24 further comprising expanding a length of transmission operations granted to admitted traffic streams on a predetermined basis in order to avoid possible queue overflows.

26. The computer readable medium of claim 25 further comprising utilizing a pending queue value for each of the admitted traffic streams and an aggregated pending queue value to derive a required transmission operation expansion length.

27. The computer readable medium of claim 26 further comprising utilizing a programmable threshold as a value needing to be reached by the pending queue value in order to trigger transmission operation length expansion.

28. The computer readable medium of claim 27 further comprising preventing transmission operation length expansion when a maximum service interval parameter of the traffic streams that should be serviced after the transmission operation length expansion is violated.

29. The computer readable medium of claim 28 further comprising re-polling traffic streams for which the transmission operation length expansion was not allowed substantially immediately after an end of all scheduled transmission operations within a current service interval using transmission operations with a length equal to the required transmission operation expansion length.
